(19) United States
(12) Patent Application Publication
(10) Pub. No.: US 2020/0082660 A1
(43) Pub. Date: Mar. 12, 2020

(54) ITEM DISPENSING DEVICE

(71) Applicant: Masuki co., ltd, Saitama (JP)

(72) Inventor: Takashi Yoshida, Saitama (JP)

(21) Appl. No.: 16/684,265

(22) Filed: Nov. 14, 2019

Related U.S. Application Data
(63) Continuation of application No. PCT/JP2018/019152, filed on May 17, 2018.

(30) Foreign Application Priority Data
May 17, 2017 (JP) 2017-097772

(51) Int. Cl. G07F 11/54; G06Q 30/06; G07F 9/02

(52) U.S. Cl. CPC G07F 11/54; G07F 9/023; G06Q 30/0601

(57) ABSTRACT

In an item dispensing device, a plurality of storage portions that store items are individually detachably supported on a strut portion, an item ejection mechanism that ejects one of the items at a time, a selection manipulation portion for allowing a customer to select the storage portion, and a unit price display portion that displays a price relating to the item stored in the storage portion selected by the selection manipulation portion are individually attached to the plurality of storage portions, and an item dispensing slot for allowing the customer to take out the item ejected from the storage portion, a transportation passage through which the item ejected from the storage portion is transported to the item dispensing slot, a handle for allowing the customer to activate an ejection operation of the item ejection mechanism, and a settlement processing portion that performs settlement processing relating to vending of the item are equipped to the strut portion, and are used in common by the plurality of storage portions.

### CROSS-REFERENCE TO RELATED APPLICATIONS

This application is a continuation application of International Patent Application No. PCT/JP2018/019152 filed on May 17, 2018, which is based upon and claims the benefit of priority from the prior Japanese Patent Application No. 2017-097772, filed May 17, 2017, the entire contents of which are incorporated herein by reference.

### FIELD

The present invention relates to an item dispensing device for dispensing one capsule item at a time.

### BACKGROUND

Typically, capsule vending machines (referred to as “item dispensing devices” in this specification) for vending various items, such as spherical capsule toys or stationery, are known. In an item dispensing device, a disc-shaped rotor is placed in a lower part of a stock case, which stores a large number of items C. A plurality of, for example, four, circular holes (item holders) are arranged in the rotor along its circumferential direction. One capsule C is held in each of the holes. One circular hole (item ejection hole) is opened in the bottom of the stock case. For example, when a customer manually turns a handle, which is connected to a rotor mechanism, thereby rotating a rotor, and any of the four item holders of the rotor is aligned with the item ejection hole in the bottom of the stock case, a capsule C falls through the item ejection hole to an item dispensing portion. The customer can take out the capsule C from the item dispensing portion. This structure similarly applies to Patent Literature 1.

### CITATION LIST

### Patent Literature

Patent Literature 1: Japanese Patent Laid-Open No. 2013-149229

### SUMMARY OF INVENTION

### Technical Problem

Item dispensing devices, such as the capsule vending machine described above, have the following problem. Items of the same kind are stored in a stock case of the item dispensing device. To vend multiple kinds of items, it is necessary to arrange a plurality of item dispensing devices in a lateral direction and, further, to stack the item dispensing devices in the longitudinal direction. The item dispensing device individually includes, in addition to the stock case that stores items, an ejection mechanism attached to the stock case, such as a rotor and a handle, a dispensing slot, a payment mechanism and the like so that the item dispensing device requires a substantial size. The item dispensing devices are installed at blank spaces in stores in many cases. In such an installation space, there is a limitation on the number of item dispensing devices which can be installed, so that vending of multiple kinds of items is limited. Further, vending of multiple kinds of items also has a problem that inventory management and the like become complicated.

An object is to provide an item dispensing device suitable for vending of multiple kinds of items.

### Solution to Problem

In an item dispensing device according to this embodiment, a plurality of storage portions that store items are individually detachably supported on a strut portion, an item ejection mechanism that ejects one of the items at a time, a selection manipulation portion for allowing a customer to select the storage portion, and a display portion that displays a price relating to the item stored in the storage portion selected by the selection manipulation portion are individually attached to the plurality of storage portions, and an item dispensing slot for allowing the customer to take out the item ejected from the storage portion, a transportation passage through which the item ejected from the storage portion is transported to the item dispensing slot, a trigger manipulation portion for allowing the customer to activate an ejection operation of the item ejection mechanism, and a settlement processing portion that performs settlement processing relating to vending of the item are equipped to the strut portion, and are used in common by the plurality of storage portions.

### BRIEF DESCRIPTION OF THE VIEWS OF THE DRAWING

FIG. 1 is a view showing the overall configuration of an item vending management system which includes an item dispensing device according to this embodiment and a server device.

FIGS. 2A and 2B are view showing one example of installers and item providers for the item dispensing device shown in FIG. 1.

FIG. 3 is a view showing the item dispensing device shown in FIG. 1, a shared transportation passage, and a line sensor installed in the shared transportation passage.

FIG. 4 is an exploded view of an item ejection mechanism equipped to a stock case shown in FIG. 1.

FIG. 5 is a plan view of a rotor showing pressing protrusions on the lower surface of the roller that presses a rotor switch shown in FIG. 4.

FIG. 6 is an AA sectional view in FIG. 5.

FIG. 7 is a block diagram showing the configuration of the item dispensing device shown in FIG. 1.

FIGS. 8A, 8B, 8C, and 8D are supplementary explanatory views relating to processing of specifying passing of an item and the number of passing items by a sensor processing portion shown in FIG. 7.

FIG. 9 is a flowchart showing an item vending operation of the item dispensing device shown in FIG. 1.

FIG. 10 is a view showing a data flow of an item vending management system shown in FIG. 1.

### DETAILED DESCRIPTION

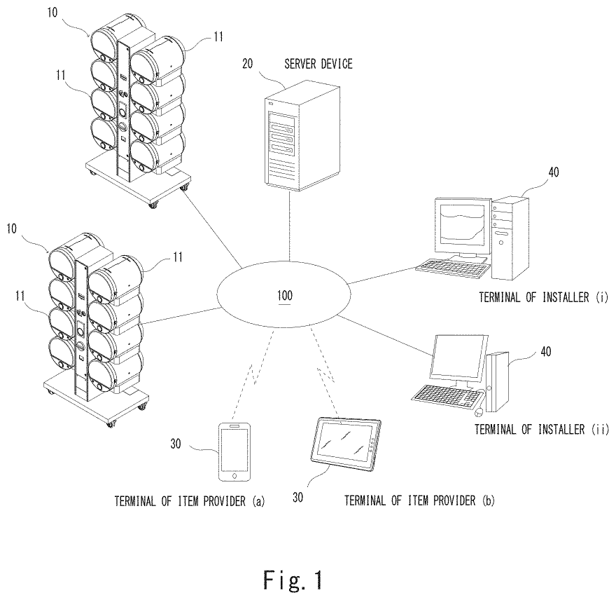

Hereinafter, an embodiment of the present invention will be described with reference to drawings. As shown in FIG. 1, in an item vending management system, a plurality of item dispensing devices 10 are connected to a server device 20 via a public communication network 100. Each of the item dispensing devices 10 includes a plurality of, eight in this embodiment, stock case units 11. Information processing terminals 30, such as personal computers or tablets, managed by respective item providers (a), (b), and information processing terminals 40, such as personal computers or tablets, managed by respective installers (i), (ii), are connected to the server device 20 via a public communication network 100.

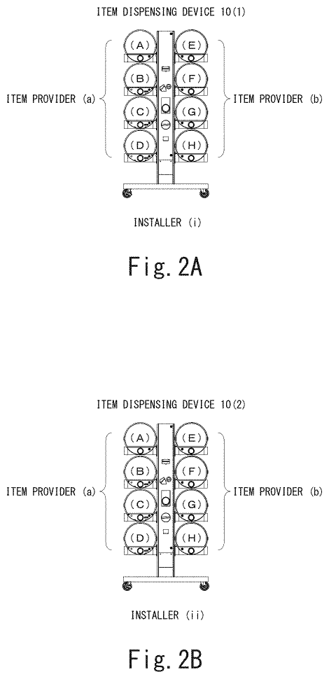

For the sake of convenience of the description, as exemplified in FIGS. 2A and 2B, assume that two item dispensing devices 10 are respectively installed at locations respectively designated by the installers (i), (ii). Further, items stored in sixteen stock case units 11 in total of the two item dispensing devices 10 are provided by, for example, two item providers (a), (b). For example, items provided by the item provider (a) are stored in stock case units 11(A) to (D) of item dispensing devices 10(1), (2). Items provided by the item provider (b) are stored in stock case units 11(E) to (H) of the item dispensing devices 10(1), (2).

The item dispensing device 10 has various functions of an automatic vending device of a type which vends one piece of merchandise at a time with a manipulation of a handle, the automatic vending device being similar to the item dispensing device 10. That is, the item dispensing device 10 has functions, such as a function of stocking items (merchandise), a function of allowing a customer to select merchandise for purchase, a function of displaying a price, a settlement function, a function of ejecting one piece of merchandise at a time, and a trigger function of causing an ejection function to be activated with a manual manipulation of a handle or the like performed by the customer. The important concept of the item dispensing device 10 according to this embodiment lies in the distribution and concentration of the above-mentioned plurality of functions. That is the item dispensing device 10 includes the plurality of stock case units 11, and the functions separately equipped to each of the plurality of stock case units 11 in a distributed manner are distinguished from the functions which are not equipped to the plurality of stock case units 11, but are used in common by the plurality of stock case units 11. With such a configuration, not only that the entire cost of the item dispensing device 10 can be suppressed, but also that the number of stock case units 11 equipped to the item dispensing device 10 can be easily increased or decreased. Further, such a configuration realizes the reduction in size of the stock case units 11, thus realizing an increase in the maximum number of the stock case units 11 with which the item dispensing device 10 can be equipped. In this embodiment, the stock case unit 11 is equipped with the function of allowing a customer to select merchandise for purchase and the function of displaying a price in addition to the function of stocking items (merchandise) and the function of ejecting one piece of merchandise at a time which the stock case unit 11 essentially has. Meanwhile, the settlement function and the trigger function of causing the ejection function to be activated with a manual manipulation of a handle or the like performed by a customer are used in common by the plurality of stock case units 11.

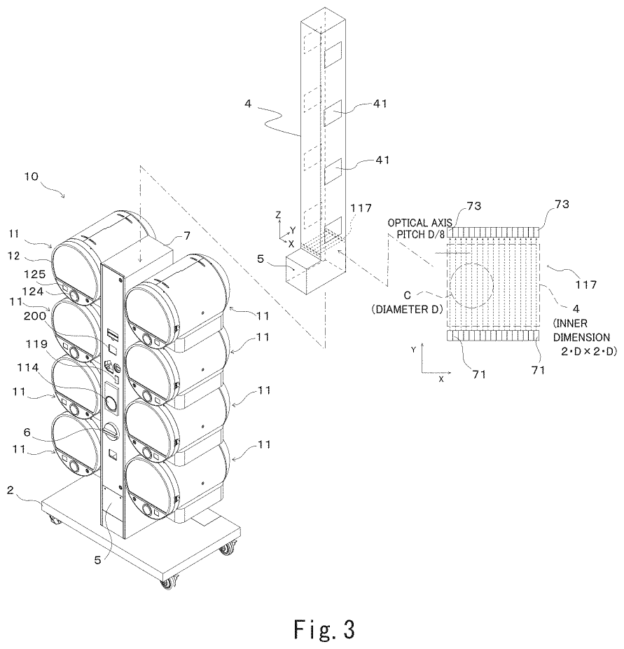

FIG. 3 shows the item dispensing device according to this embodiment. A strut portion 7 is erected on a support stand 2. Four stock case units 11 are supported on each of both sides of the strut portion 7, for example. The stock case units 11 are detachably supported on the strut portion 7. There may be a situation where the number of stock case units 11 to be mounted on the strut portion 7 is desired to be changed due to various reasons, such as the space limitations of an installation place. The item dispensing device according to this embodiment can cope with such a situation in a flexible manner. To cope with such a situation, one of important characteristics of this embodiment is to appropriately differentiate functions equipped to the stock case units 11 individually from functions which are used in common by the plurality of stock case units 11.

Each stock case unit 11 includes a housing (stock case) 12 which is formed into a cylindrical shape or a barrel shape and which is typically transparent, and a large number of capsules C (items) are stored in the stock case 12. The front surface of the stock case 12 is equipped with a merchandise selection button 124 and an individual unit price display portion 125, the merchandise selection button 124 being provided for allowing a customer to select the purchase of merchandise stored in the stock case 12, and the individual unit price display portion 125 being provided for individually displaying a merchandise price (unit price) of the merchandise stored in the stock case 12 or attribution information, such as specification and characteristics relating to the merchandise. An item ejection mechanism (described later) for ejecting one capsule C at a time is disposed in the bottom of each stock case 12.

A shared transportation passage 4 is inserted into the strut portion 7. An item dispensing slot 5 is opened at the lowermost position of the shared transportation passage 4, and four inlets 41 are opened on each of both sides of the shared transportation passage 4. An ejection slot of the item ejection mechanism of each stock case unit 11 is aligned with the inlet 41. A front panel 7 of the strut portion 7 is equipped with a handle 6 as a manual manipulation portion forming a trigger which causes an item to be ejected from the stock case unit 11, an electronic money reader/writer 114 for electronic settlement, and a reset button 119. The handle 6, the electronic money reader/writer 114 for electronic settlement, the reset button 119, and a total amount display portion 200 are used in common by the plurality of stock case units 11.

When any one merchandise selection button 124 or any number of two or more of the merchandise selection buttons 124 is pressed by a customer, settlement is completed, and the handle 6 is manually rotated, an electric actuator is driven which operates the item ejection mechanism of the stock case unit 11 corresponding to the one or two or more buttons 124. With such an operation, the item ejection mechanism is operated so that the item stored in the stock case unit 11 is ejected, and is transported to the item dispensing slot 5 through the shared transportation passage 4. A power source of the electric actuator is typically an electric motor. However, the power source may also be a power source of another type, such as a solenoid.

A line sensor (area sensor) 117 is installed in the shared transportation passage 4 at a position between the lowermost inlet 41 and the item dispensing slot 5. The line sensor 117 includes a plurality of optical sensors (photoelectric sensors) each of which includes a light emitting element 71 and a light receiving element 73 forming a pair. The plurality of optical sensors are arranged to be orthogonal to the central axis (Z axis) of the shared transportation passage 4, and to be parallel to the width direction (X axis direction) of the shared transportation passage 4 along which the left and right inlets 41 of the shared transportation passage 4 oppose each other. With such a configuration, for example, even in the case where two capsules C are substantially simultaneously ejected from two stock cases 20 disposed at the same level on the left and right of the shared transportation passage 4, thus falling through the shared transportation passage 4 side by side and passing through the line sensor 117, it is possible to specify the number of capsules C passing through the line sensor 117.

Typically, to prevent clogging in the shared transportation passage 4 even in the case where two capsules C fall side by side, assuming the diameter of the capsule C as “D”, the shared transportation passage 4 is configured to have an inner dimension of 2.D×2.D in the case of a rectangular cylindrical shape, and to have an inner diameter of 2.D in the case of a cylindrical shape. Further, to ensure accuracy in determination of the passing of the capsule C and the number of passing capsules C from the shape of the capsule C, typically, from a spherical shape, the line sensor 117 is preferably configured to have the optical axis pitch of D/8.

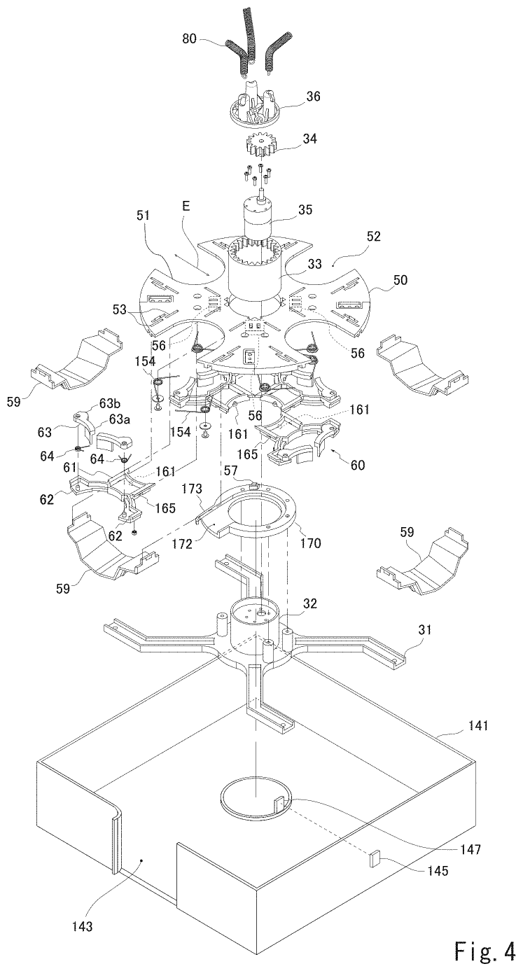

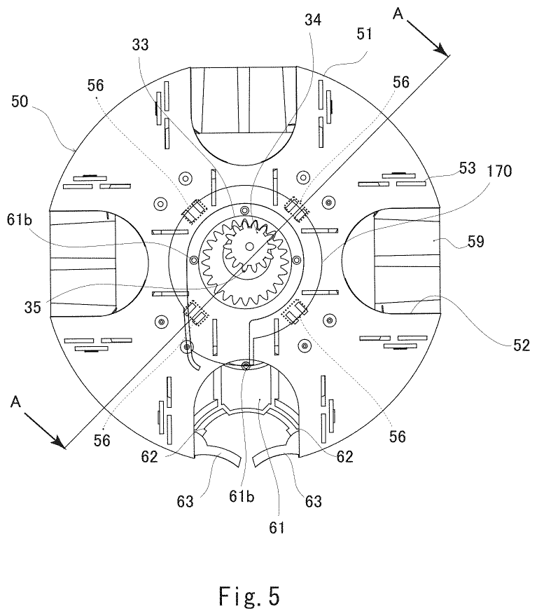

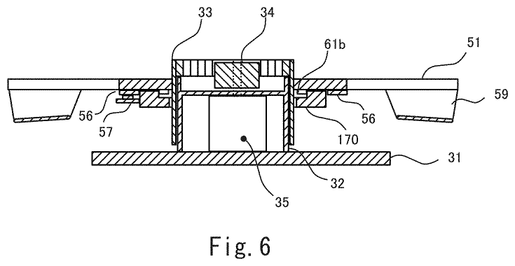

FIG. 4 to FIG. 6 show the item ejection mechanism incorporated in each stock case 12. The item ejection mechanism is installed on a bottom 141 of the stock case 12 having a bottomed cylindrical shape. Unlike the prior art, a falling hole which allows the capsule C to fall is not opened on the bottom 141, whereby an item ejection port 143 slightly larger than the capsule C is opened at a portion of the side wall of the bottom 141. The item ejection port 143 is aligned with the inlet 41 of the shared transportation passage 4. A mechanism support stand 31 is fixed to the bottom 141, and the mechanism support stand 31 includes a shaft support portion 32 having the axial direction extending in the vertical direction. A cylindrical rotary shaft 33 having internal teeth is supported on the shaft support portion 32 in a rotatable manner about the axis extending in the vertical direction.

A gear 34 is meshed with the internal teeth of the rotary shaft 33, and a drive shaft of an electric motor 35 is connected to the gear 34. The motor 35 is held in the cylindrical rotary shaft 33. Such a holding structure and a speed reduction mechanism formed of the internal teeth of the rotary shaft 33 and the gear 34 meshed with the internal teeth of the rotary shaft 33 enable the significant reduction in size of the device per se and, further, the installation of trays 59 described later.

A cap 36 which covers the rotary shaft 33 is mounted on the upper part of the rotary shaft 33. A plurality of, three in this embodiment, stirrers 80 which stir the capsules C in the stock case 12 are mounted on the upper part of the cap 36. A coil spring is typically used for the stirrer 80.

A disc-shaped rotor 50 is coaxially mounted on the rotary shaft 33, and four sets of sliders 60, which are rotated integrally with the rotor 50, are disposed on the lower surface side of the rotor 50. The sliders 60 rotate together with the rotor 50. Each slider 60 is biased by a pair of torsion bar springs 154 having the same spring constant in a direction along which the slider 60 is pushed radially outward. The pair of torsion bar springs 154 is pivotally supported at symmetrical positions on the back surface of a circular plate 51 of the rotor 50. Each torsion bar spring 154 has, in a compressed state, one end thereof brought into contact with the protrusion of the circular plate 51, and the other end thereof inserted into a spring receiver 165 formed at the side part of the front surface of the slider 60. When the slider 60 is outwardly pushed out by the torsion bar springs 154, lever members 63 disposed at the distal end of the slider 60 turn outward against torsion bar springs 64.

A protrusion (cam follower) 161 having a columnar shape is mounted on the rotary shaft side of the back surface of the slider 60. A bearing is used as the cam follower 161, for example. The cam follower 161 slides along the inner peripheral surface of a rail 170, fixed to a pedestal, with the rotation of the rotor 50. The rail 170 is formed in an annular shape, and the part of the rail 170 is opened. The opening width (opening angle) of this opening portion 172 is substantially half of the opening width (opening angle) of the item ejection port 143, and one end of the opening portion 172 on the upstream side is aligned with the opening center of the item ejection port 143. A guide rail 173 having a straight line shape or a gentle arcuate shape is coupled to one end of the opening portion 172 of the rail 170 on the downstream side such that the guide rail 173 forms a tangent to the rail 170.

The cam follower 161 is pressed against the inner peripheral wall surface of the rail 170 in a state where the torsion bar springs 154 are compressed. During a period of movement of the cam follower 161 along the rail 170 with the rotation of the rotor 50, the slider 60 is maintained at a regular position (standby position) at which the slider 60 approaches closest to the center of rotation. When the cam follower 161 reaches the opening portion 172 of the rail 170 with the rotation of the rotor 50, the torsion bar springs 154 are released swiftly, thus vigorously snapping the slider 60 radially outward. With the movement of the slider 60, the lever members 63 disposed at the distal end of the slider 60 are turned to a pushing position from the storage position of the lever members 63. Due to the movement of the slider 60 and the turning of the lever members 63, the capsule C held in an item holder 52 of the rotor 50 is vigorously snapped in the substantially horizontal direction, thus being ejected to the outside from the item ejection port 143.

When the rotor 50 rotates, the cam follower 161 abuts the guide rail 173, and slides on the inner wall surface of the guide rail 173, thus gradually approaching the center of rotation. Then, the cam follower 161 returns to the annular rail 170 from the guide rail 173.

With such a structure, the springs 154 in a compressed state are released swiftly so that the capsule C can be vigorously snapped in the substantially horizontal direction by an instantaneous repulsive force generated at the time of release of the springs 154. Thus, not only a spherical capsule C, but also a capsule C having an elliptical spherical shape which is not a spherical shape can be ejected from the item ejection port 143 with certainty without unexpected stops.

A plurality of, four in this embodiment, item holders 52 which open radially outward and which have a substantially half-oval shape are provided to the circular plate 51 of the rotor 50 in a distributed manner along the circumferential direction of the circular plate 51. The outer peripheral surface of the circular plate 51 is disposed with a slight gap with respect to the inner wall surface of the bottom 141. Each item holder 52 is formed larger than the outer diameter of the capsule C, and has a function of transporting the capsule C held in the item holder 52 in the rotational direction. Further, the central axis of the item holder 52 is formed along the radial direction of the rotary shaft 33. Straight guides 53 for guiding the slider 60 are provided to the circular plate 51 along each item holder 52. The straight guides 53 are disposed parallel to the radial direction. With the provision of the straight guides 53, the slider 60 is mounted in a reciprocable manner in a pushing direction of the item holder 52, that is, in the radial direction.

In addition, the tray 59 which receives the capsule C is attached below each item holder 52 of the rotor 50. The bottom plate of the tray 59 is maintained in a substantially horizontal state where the bottom plate is inclined downward toward the outside at an angle within a range from the horizontal (zero degrees) to 10 degrees. The tray 59 rotates together with the rotor 50 while maintaining the state of holding the capsule C. If the tray 59 is not present, the capsule C held in the item holder 52 rolls and slides on the bottom plate of the stock case 12 together with the rotation of the rotor 50. The capsule C has a spherical shape obtained by fitting a pair of hemispheres, and a joint between these hemispheres is taped so as to prevent the separation of the pair of hemispheres and exposure of the item in the hemispheres before the item is handed to a purchaser of the item. Accordingly, in the case where the tray 59 is not provided, the capsule C rolls and slides on the bottom plate of the stock case 12 so that there is a possibility that the tape is peeled off or is damaged. The structure of providing the tray 59 can avoid such a situation.

A momentary press rotor switch 57, which is turned on only when being pressed, is installed on the outer peripheral wall surface of the rail 170. The rotor switch 57 is typically disposed on the downstream side of the guide rail 173. Four pressing-down protrusions 56 are disposed on the lower surface of the circular plate 51 of the rotor 50 in a distributed manner along the circumferential direction of the rotor 50 at equal angular (90 degrees) intervals. The pressing portion of the rotor switch 57 is positioned on the circulating track of the pressing-down protrusions 56. The positional relationship between the pressing-down protrusions 56 and the rotor switch 57 is set such that the rotor switch 57 is turned on at each of four angles of the rotor 50 where the item holder 52 of the rotor 50 is aligned with the item ejection port 143, and the capsule C is ejected to the outside from the item ejection port 143 due to the movement of the slider 60.

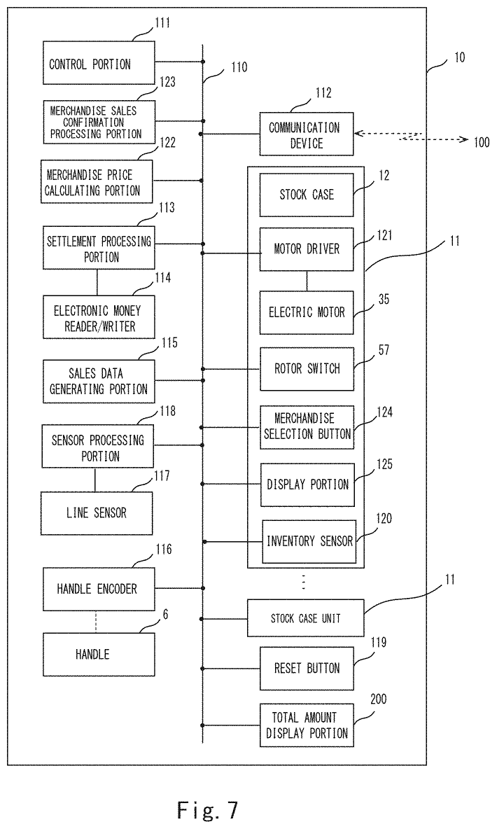

Further, in the bottom 141 of the stock case 12 having a bottomed cylindrical shape, an optical sensor (FIG. 7, inventory sensor 120), formed of a light emitting element 145 and a light receiving element 147, is installed such that the light emitting element 145 and the light receiving element 147 oppose each other with the tray 59 of the item holder 52 interposed therebetween, and the optical axis of the optical sensor is substantially parallel to the radius of the rotary shaft 33. Typically, the inventory sensor is installed at a standby position immediately upstream of the item ejection port 143, that is, at a position upstream of the position of the item ejection port 143 by 90 degrees. An output signal from the inventory sensor changes depending on whether or not the capsule C is held in the tray 59 of the item holder 52. Accordingly, based on an output signal from the inventory sensor, it is possible to determine whether or not at least one capsule C is held in the stock case 12.

FIG. 7 shows the function block of the item dispensing device 10 according to this embodiment. The item dispensing device 10 includes, in addition to the plurality of stock case units 11, a control portion 111 which controls the entire operation, a control/data bus 110, the reset button 119, the handle 6, a handle encoder 116 for detecting the rotation of the handle 6, a communication device 112 which communicates with the server device 20 via the public communication network 100, a merchandise price calculating portion 122, a settlement processing portion 113, the electronic money reader/writer 114, the line sensor 117, a sensor processing portion 118, a sales data generating portion 115, and a merchandise sales confirmation processing portion 123.

The control portion 111, the reset button 119, the handle 6, the handle encoder 116, the communication device 112, the merchandise price calculating portion 122, the settlement processing portion 113, the electronic money reader/writer 114, the line sensor 117, the sensor processing portion 118, the sales data generating portion 115, the merchandise sales confirmation processing portion 123, and the total amount display portion 200 are not individually provided to the plurality of stock case units 11, but are provided to the item dispensing device 10 as a single body, thus being used in common by the plurality of stock case units 11.

Meanwhile, each stock case unit 11 is equipped with the merchandise selection button 124, the unit price display portion 125 and the inventory sensor 120 in addition to the stock case 12, the electric motor 35 for rotating the rotor 50, a motor driver 121 which supplies drive power to the electric motor 35, and the rotor switch 57 which are essentially included by the stock case unit 11.

The control portion 111 controls the motor driver 121 based on the output from the handle encoder 116 so as to cause the rotor 50 to rotate in synchronism with the rotation of the handle 6. Typically, the control portion 111 outputs a control signal to instruct the supply of unit power for causing the rotor 50 to rotate by five degrees every time that the handle 6 rotates by 20 degrees from the motor driver 121 to the electric motor 35.

A rotary encoder which is engaged with the rotary shaft of the handle 6 is mounted as the handle encoder 116, and the handle encoder 116 generates a pulse for every rotation by a predetermined angle. With such a configuration, the rotation angle of the handle 6 is detected. The merchandise price calculating portion 122 is formed of a nonvolatile memory, for example, and stores merchandise price data of the merchandise in association with identification numbers of the respective stock case units 11. The merchandise price is outputted to and displayed on the unit price display portion 125 of the corresponding stock case unit 11 under the control of the control portion 111. Further, the merchandise price calculating portion 122 stores attribution information, such as the specification and characteristics of merchandise stored in the stock case unit 11, in association with the identification numbers of the respective stock case units 11. Attribution information is outputted to the unit price display portion 125 of the stock case unit 11 under the control of the control portion 111, and is displayed alternately with a merchandise price or together with the merchandise price. The merchandise price data and attribution information in the merchandise price calculating portion 122 are updated as needed to price data and attribution information received from the server device 20 via the communication device 112.

When a customer performs a pressing manipulation of the single merchandise selection button 124, the control portion 111 causes the total amount display portion 200 to display the unit price. When the customer performs a pressing manipulation of two or more merchandise selection buttons 124 in combination, the control portion 111 causes the total amount display portion 200 to display the total amount. In addition, when any malfunction or breakdown occurs in the item dispensing device 10, the control portion 111 causes the total amount display portion 200 to display texts or an error code expressing the malfunction or breakdown state in place of the total amount.

The settlement processing portion 113 communicates with an external settlement server device according to electronic money information which is read via the electronic money reader/writer 114 to perform settlement processing for a merchandise price calculated by the merchandise price calculating portion 122. Note that settlement processing is not limited to electronic money settlement, and may be cash settlement which uses bills and coins, or may be settlement which uses electronic money and bills and coins in combination. In such a case, a bill identification machine unit (bill validator) and an electronic coin sorter (coin mechanism) are connected to the settlement processing portion 113.

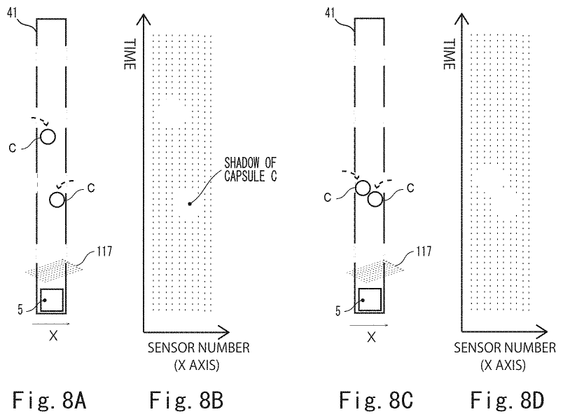

The sensor processing portion 118 drives the line sensor 117, and performs processing on the output from the line sensor 117 to specify the passing of the capsule C and the number of passing capsules C based on the shape (spherical shape) of the output. FIGS. 8A to 8D show one example of the specifying processing. In this embodiment, assuming that an output when no obstacle (capsule C) is present between the light emitting element 71 and the light receiving element 73 is “1”, and an output when an obstacle (capsule C) is present between the light emitting element 71 and the light receiving element 73 is “0”, a circular shadow which corresponds to the spherical shape of the capsule C is generated in a sensor image where the sensor number is taken on an axis of abscissas, and a time is taken on an axis of ordinates. As shown in FIG. 8A, when two capsules C falling from upper and lower inlets 41, that is, from two inlets 41, pass through the line sensor 117, shadows of the two capsules C which are separated from each other as shown in FIG. 8B appear. When the two capsules C falling from the two inlets 41 disposed adjacent to each other at the same height pass through the line sensor 117 as shown in FIG. 8C, shadows of the two capsules C appear in a contact or adjacent state as shown in FIG. 8D. By extracting the shadows of the capsules C from the sensor image, the passing of the capsules C and the number of passing capsules C can be specified with high accuracy even if the capsules C fall substantially simultaneously.

An optical sensor may be individually provided to the item ejection port 143 of the stock case unit 11 in place of the line sensor 117. With the provision of such an optical sensor, it is possible to detect the passing (ejection) of the capsule C for each stock case unit 11. The sensor processing portion 118 can specify the ejection of the capsule C and the number of ejections by performing processing on outputs from the plurality of optical sensors provided to the plurality of stock case units 11.

When a customer performs pressing manipulation of one or a plurality of merchandise selection buttons 124, and the settlement for the buttons is completed, the sales data generating portion 115 generates item sales data including, in addition to sales date, an identification number for identifying the item dispensing device 10, and an identification number for individually identifying the stock case unit 11 of the item dispensing device 10. Although this sales data is transmitted from the communication device 112 to the server device 20, the transmission of the sales data is made to stand by until settlement is completed by the control of the control portion 111, and merchandise vending is ultimately confirmed by the merchandise sales confirmation processing portion 123. In the case where merchandise vending is not ultimately confirmed by the merchandise sales confirmation processing portion 123 regardless of the completion of the settlement, sales data is not transmitted, and the control portion 111 transmits error data indicating an abnormal situation where merchandise vending is not performed regardless of the completion of the settlement.

Assume the case where it is determined that based on the output (the number of pulses) from the handle encoder 116 of the handle 6, a rotation angle by which a rotation manipulation of the handle 6 is performed reaches 360 degrees or a predetermined angle approximate to 360 degrees, and that an ON signal is generated from the rotor switch 57 so that the rotor 50 is rotated until any of the plurality of item holders 52 is aligned with the item ejection port 143, and the passing of the capsule C is specified by the sensor processing portion 118, and the number of passing capsules C agrees with the number of merchandise on which settlement is performed. In such a case, the merchandise sales confirmation processing portion 123 confirms that merchandise vending is ultimately performed. When the control portion 111 receives a settlement complete signal from the settlement processing portion 113, and a merchandise sales confirmation signal from the merchandise sales confirmation processing portion 123, the control portion 111 permits or instructs the transmission of sales data to the sales data generating portion 115 or the communication device 112.

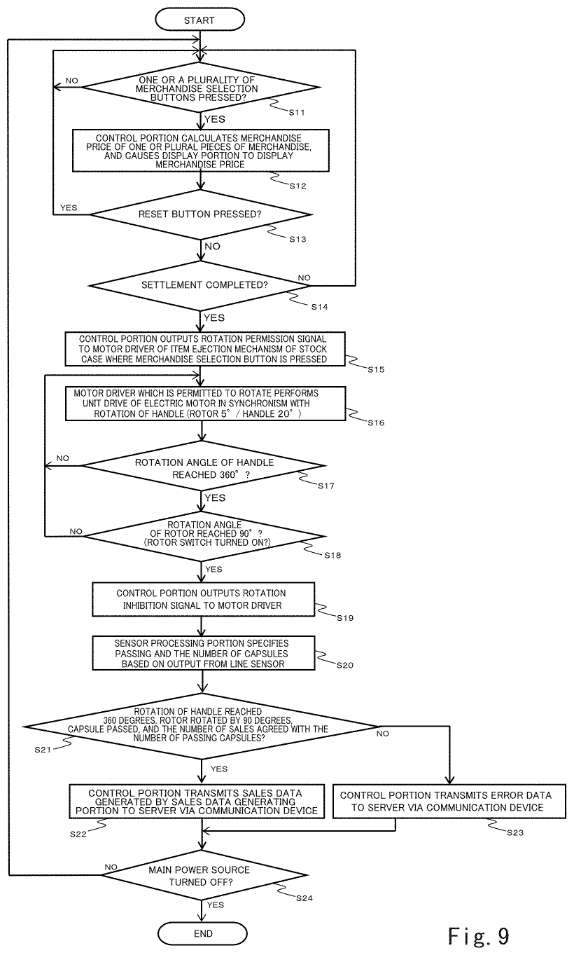

FIG. 9 shows item vending operation procedure of the item dispensing device according to this embodiment. A customer presses the merchandise selection button 124 of the stock case unit 11 in which desired merchandise is stored. When there are a plurality of desired merchandise, the customer presses the merchandise selection buttons 124 of two or more stock case units 11 in which the merchandise is stored. The control portion 111 stands by for a pressing manipulation of one or a plurality of merchandise selection buttons 124 (S11). When the pressing manipulation is detected, the control portion 111 receives, from the merchandise price calculating portion 122, data of a merchandise price of an item stored in one or the plurality of stock case units 11 equipped with the one or a plurality of merchandise selection buttons 124, and the control portion 111 causes the unit price display portion 125 to display the merchandise price (S12).

The control portion 111 stands by for a lapse of a predetermined time period from a time when the pressing manipulation of the merchandise selection button 124 is performed by a customer. When the reset button 119 is pressed during such a stand⁻by period (S13, YES), the processing returns to step S11, and the control portion 111 stands by for a pressing manipulation of the merchandise selection button 124. When the reset button 119 is not pressed within the stand-by period (S13, NO), and the inventory of at least one capsule C in the stock case 12 is confirmed based on the output from the inventory sensor, the control portion 111 instructs the settlement processing portion 113 to start the settlement processing.

When there is no inventory of the capsule C in the stock case 12, the control portion 111 turns off the unit price display portion 125, and accepts no manipulation of the merchandise selection button 124. That is, a state is brought about where merchandise selection cannot be performed (vending stop). Further, when there is no inventory in the stock case 12, the control portion 111 transmits a signal indicating no inventory of the merchandise (out-of-stock signal) to the server device 20 from the communication device 112 together with the identification number of the stock case 12 and the identification number of the item dispensing device 10. When the server device 20 receives the out-of-stock signal from the item dispensing device 10, the server device 20 transmits an out-of-stock alert notification to an installer's terminal 40 of the item dispensing device 10 together with the identification number of the stock case 12 and the identification number of the item dispensing device 10. With such operations, the installer can resupply merchandise in the stock case 12 of the item dispensing device 10 which is out of stock. Further, when the server device 20 receives the out-of-stock signal from the item dispensing device 10, the server device 20 transmits an out-of-stock alert notification to a terminal 30 of a provider providing merchandise to the stock case 12 which is out of stock together with the identification number of the stock case 12 and the identification number of the item dispensing device 10. With such operations, the item provider can deliver out-of-stock merchandise to the installer or the like.

The settlement processing portion 113 communicates with a settlement server device of an external settlement agent according to electronic money information and vendor information read through the electronic money reader/writer 114 to perform settlement processing. When settlement is normally completed, the settlement processing portion 113 transmits a settlement completion notification to the control portion 111, whereas when settlement is not normally completed, the settlement processing portion 113 transmits a settlement non-completion notification to the control portion 111. When the control portion 111 receives the settlement completion notification from the settlement processing portion 113 (S14, YES), the processing advances to next step S15 where the control portion 111 outputs a rotation permission signal to the motor driver 121 of the item ejection mechanism of one or the plurality of stock case units 11 selected by the pressing manipulation of the merchandise selection button 124.

During a period where the motor driver 121 receives the rotation permission signal from the control portion 111, the motor driver 121 supplies a unit power to the electric motor 35 every time that the number of pulses received from the handle encoder 116 reaches a predetermined number (S16). The predetermined number is typically set to the number of pulses which corresponds to the rotation of the handle 6 by 20 degrees, and the unit power is adjusted to power necessary for rotating the rotor 50 by 5 degrees. Accordingly, the rotor 50 rotates in synchronism with the rotation manipulation of the handle 6. When the handle 6 rotates by 360 degrees, the rotor 50 rotates by 90 degrees so that the item holder 52 is aligned with the item ejection port 143 whereby the capsule C held in the item holder 52 is ejected to the shared transportation passage 4 from the item ejection port 143 via the inlet 41.

The control portion 111 determines whether or not the number of pulses received from the handle encoder 116 reaches the predetermined number (S17), and determines the reception of an ON signal from the rotor switch 57 (S18). In the case where the number of pulses received from the handle encoder 116 reaches the predetermined number (S17, YES), and the control portion 111 receives the ON signal from the rotor switch 57 (S18, YES), the control portion 111 outputs a rotation inhibition signal to the motor driver 121, or stops a rotation permission signal (S19). Synchronous rotation of the rotor 50 with respect to the rotation manipulation of the handle 6 is continued until the handle 6 is rotated by 360 degrees and the rotor 50 is rotated by 90 degrees. At a point of time when the rotation angle of the handle 6 reaches 360 degrees, and the rotation angle of the rotor 50 reaches 90 degrees, the rotation of the rotor 50 is stopped.

The ejected capsule C falls to the item dispensing slot 5 through the shared transportation passage 4, and passes through the line sensor 117. The sensor processing portion 118 extracts the shadow of a sphere expressing the capsule C by performing processing on a signal train (sensor image) outputted from the line sensor 117 from a point of time when a rotation inhibition signal is outputted from the control portion 111 until a predetermined time period, such as two seconds, elapses, for example, thus specifying the passing of the capsule C and the number of passing capsules C. At the same time, the sensor processing portion 118 transmits data showing the passing of the capsule C and the number of passing capsules C to the control portion 111 (S20).

When all of the conditions are satisfied, that is, when the handle 6 is rotated by 360 degrees based on the output from the handle encoder 116, the rotor 50 is rotated by 90 degrees based on the output from the rotor switch 57, and passing of the capsule C and the agreement of the number of sales of merchandise with the number of passing capsules C are specified from the output from the sensor processing portion 118 (S21, YES), the merchandise sales confirmation processing portion 123 transmits a merchandise sales confirmation signal to the control portion 111. With the reception of the merchandise sales confirmation signal, the control portion 111 causes sales data generated by the sales data generating portion 115 to be transmitted to the server device 20 via the communication device 112 (S22). The rotation of the handle 6 by 360 degrees and the rotation of the rotor 50 by 90 degrees indicate that an ejection operation of the capsule C is normally completed and the capsule C is ejected to the shared transportation passage 4 from the stock case unit 11. Further, passing of the capsule C through the line sensor 117 and agreement of the number of sales of merchandise with the number of passing capsules C indicate that the capsule C purchased by a customer is normally delivered to the customer.

When any of the conditions of the rotation of the handle 6 by 360 degrees, the rotation of the rotor 50 by 90 degrees, passing of the capsule C and, further, the agreement of the number of sales of merchandise with the number of passing capsules C is not satisfied (S21, NO), the control portion 111 does not receive a merchandise sales confirmation signal. In the case where the control portion 111 does not receive the merchandise sales confirmation signal, the control portion 111 does not permit the transmission of sales data. At this point of operation, the control portion 111 causes error data including a code specifying at least one failure condition to be transmitted to the server device 20 via the communication device 112 (S23). The server device 20 can specify the failure condition from the error data so that it is possible to arrange customer support and maintenance support corresponding to the failure condition.

Unless a main power source is in an OFF state (S24, NO), the processing returns to step S11, and the control portion 111 stands by for the pressing manipulation of the merchandise selection button 124. When the main power source is in an OFF state (S24, YES), the processing is finished.

By driving the item ejection mechanism by a motor as described above, the structural body, such as the handle and the transportation passage for the capsule C, and the settlement processing can be used in common by the plurality of stock cases and hence, the item dispensing device can be adaptive to the circumstance of vending multiple kinds of items by increasing the number of stock cases while the size of the entire item dispensing device is suppressed.

Further, elimination or reduction of “non-ejection of the capsule C” and “erroneous ejection of the capsule C” which are required to be solved in driving the item ejection mechanism by a motor can be endured by causing the rotor to continue the rotation until the handle is rotated by 360 degrees and the rotor is rotated by 90 degrees, meanwhile by inhibiting the rotation of the rotor at a point of time when the rotation angle of the handle reaches 360 degrees and the rotation angle of the rotor reaches 90 degrees.

In the circumstance of vending of multiple kinds of items, a situation is anticipated that installers differ for respective item dispensing devices and, further, each stock case unit has different item provider. In such a situation where it is necessary to provide data of the number of sales of items to the larger number of installers and item providers, sales data is generated which includes, in addition to an identification number of the item dispensing device, an identification number by which the stock case can be identified and hence, it is possible to cope with such a situation.

Sales data is transmitted to the server device from the item dispensing device when all conditions of the rotation of the handle 6 by 360 degrees, the rotation of the rotor 50 by 90 degrees, passing of the capsule C through the shared transportation passage and, further, the agreement of the number of sales of merchandise with the number of passing capsules C are satisfied. Accordingly, the server device can confirm the normal completion of the item ejection operation and the normal completion of the vending of the item with the reception of the sales data. Further, when any of the above-mentioned conditions is not satisfied, error data including a code specifying a failure condition is transmitted to the server device in place of sales data so that the server device 20 can specify the failure condition from the error data. Accordingly, customer support and maintenance support corresponding to the failure condition can be arranged so that such a configuration is extremely useful.

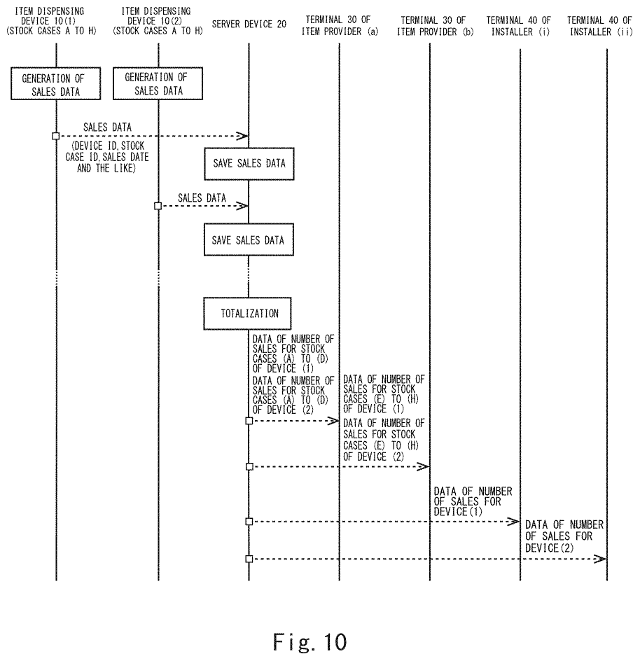

FIG. 10 shows the data flow of the item vending management system shown in FIG. 1. For the sake of convenience of the description, assume that two item dispensing devices (automatic vending machines) 10(1), 10(2) which are object to be managed by the server device 20 are connected to the server device 20 via the public communication network 100. The two item dispensing devices 10 are respectively installed at places respectively designated by the different installers (i), (ii). The installers (i), (ii) respectively manage the information processing terminals 40. Each of the two item dispensing devices 10(1), 10(2) is equipped with eight stock case units 11 in total. Assume that items provided by the item provider (a) are stored in stock case units 11(A) to (D) of the item dispensing device 10(1), items provided by the item provider (b) are stored in remaining stock case units 11(E) to (H), items provided by the item provider (a) are stored in stock case units 11(A) to (D) of another item dispensing device 10(2), and items provided by the item provider (b) are stored in remaining stock case units 11(E) to (H). The information processing terminals 30 respectively managed by the item providers (a), (b) are also connected to the server device 20 via the public communication network 100.

Every time that an item is vended by the item dispensing device 10(1), 10(2), item sales data including an identification number (device ID) for individually identifying the item dispensing device 10(1), 10(2), an identification number (stock case ID) for identifying the stock case unit 11 which stores vended merchandise (capsule C), and sales date is transmitted to the server device 20 from the item dispensing device 10(1), 10(2). The server device 20 saves sales data received from the item dispensing device 10(1), 10(2), and totalizes the sales data for each of the installers (i), (ii) and totalizes the number of sales for each of the item providers (a), (b) in a fixed cycle, for example. With this totalization processing, it is possible to obtain the number of sales for the item dispensing device 10(1), the number of sales for the item dispensing device 10(2), the number of sales for the stock case units 11(A) to (D) of the item dispensing device 10(1) and the stock case units 11(A) to (D) of another item dispensing device 10(2), and the number of sales for the stock case units 11(E) to (H) of the item dispensing device 10(1) and the stock case units 11(E) to (H) of another item dispensing device 10(2).

The data of the number of sales for the item dispensing device 10(1) obtained by the totalization processing is transmitted to a terminal 40 of the installer (i) from the server device 20, meanwhile the data of the number of sales for the item dispensing device 10(s) is transmitted to a terminal 40 of the installer (ii) from the server device 20. Further, the data of the number of sales for the stock case units 11(A) to (D) of the item dispensing device 10(1) and the stock case units 11(A) to (D) of another item dispensing device 10(2) is transmitted to the terminal 30 of the item provider (a) from the server device 20.

The data of the number of sales for the stock case units 11(E) to (H) of the item dispensing device 10(1) and the stock case units 11(E) to (H) of another item dispensing device 10(2) is transmitted to the terminal 30 of the item provider (b) from the server device 20.

From sales data collected from the plurality of item dispensing devices as described above, the number of sales is totalized for each installer of the item dispensing device per each item dispensing device and, further, the number of sales is totalized for each item providers per stock case. Then, the totalizations are transmitted to the respective terminals. Accordingly, the present invention can be adaptive to the circumstance of vending multiple kinds of items where a plurality of installers respectively install the plurality of item dispensing devices, and a large number of item providers vend items with the item dispensing device.

The present invention includes the following various aspects (1) to (11).

(1)

In an item dispensing device,

a plurality of storage portions that store items are individually detachably supported on a strut portion,

an item ejection mechanism that ejects one of the items at a time, a selection manipulation portion for allowing a customer to select the storage portion, and a display portion that displays a price relating to the item stored in the storage portion selected by the selection manipulation portion or attribution information of the item are individually attached to the plurality of storage portions, and

an item dispensing slot for allowing the customer to take out the item ejected from the storage portion, a transportation passage through which the item ejected from the storage portion is transported to the item dispensing slot, a trigger manipulation portion for allowing the customer to activate an ejection operation of the item ejection mechanism, and a settlement processing portion that performs settlement processing relating to vending of the item are equipped to the strut portion, and are used in common by the plurality of storage portions.

(2)

In the item dispensing device of (1), the item ejection mechanism is equipped with an electric actuator that generates power for ejecting the item, and the strut portion is equipped with a control portion that integrally controls the electric actuator.

(3)

In the item dispensing device of (1), the strut portion is equipped with a reset manipulation portion for allowing the customer to cancel selection of the storage portion instructed by the customer via the selection manipulation portion.

(4)

An item dispensing device includes:

a storage portion that stores items;

a handle whose rotation manipulation is manually performed to dispense the item;

a handle rotation detection portion that detects rotation of the handle;

an item ejection mechanism where a disc⁻shaped rotor is rotatably disposed in a bottom of the storage portion, a plurality of item holders each of which holds one of the items are arranged on the rotor in a circumferential direction, a rotor rotation detection portion that detects rotation of the rotor and an electric motor for rotating the rotor are engaged with the rotor, an item ejection port is provided at one portion on a circulating track of the item holder, and the item held in the item holder is ejected from the item ejection port when any of the item holders is aligned with the item ejection port with the rotation of the rotor;

a cylindrical transportation passage through which the item ejected is transported to an item dispensing slot; and

a control portion that controls the electric motor according to an output from the handle rotation detection portion and an output from the rotor rotation detection portion so as to rotate the rotor corresponding to the rotation manipulation of the handle, and so as to stop the rotation of the rotor when any of the plurality of item holders is aligned with the item ejection port with the rotation of the rotor.

(5)

In the item dispensing device of (4), the item ejection port is opened on the side wall of the lower part of the storage portion,

the item holder has a substantially half-oval shape which open outward in a radial direction of the rotor, and

the item held in the item holder is substantially horizontally ejected to the transportation passage from the item ejection port when the opening of any of the plurality of item holders is aligned with the item ejection port with the rotation of the rotor.

(6)

The item dispensing device of (4) further includes: a sales data generating portion that generates sales data of the item; and

a transmitting portion that transmits the sales data to the outside, wherein

the control portion causes the sales data to be transmitted from the transmitting portion when a rotation angle by which a rotation manipulation of the handle is performed based on an output from the handle rotation detection portion reaches 360 degrees or a predetermined angle, and when the rotor is rotated based on an output from the rotor rotation detection portion until any of the plurality of item holders is aligned with the item ejection port.

(7)

The item dispensing device of (4) further includes: a sales data generating portion that generates sales data of the item;

a transmitting portion that transmits the sales data to the outside; and

an optical sensor provided on the transportation passage at a position between the item ejection port and the item dispensing slot, wherein

the control portion causes the sales data to be transmitted from the transmitting portion when the rotation angle of the handle reaches 360 degrees or a predetermined angle, the rotor is rotated until any of the item holders is aligned with the item ejection port, and passing of the item through the transportation passage is detected based on an output from the optical sensor.

(8)

An item dispensing device includes:

a storage portion that stores items; an item ejection mechanism including a disc⁻shaped rotor, where a plurality of item holders each of which holds one of the items stored in the storage portion are arranged in a circumferential direction, and an item ejection port provided at one portion on the circulating track of the item holder, the item ejection mechanism ejecting the item held in the item holder from the item ejection port when any of the item holders is aligned with the item ejection port with the rotation of the rotor;

a cylindrical transportation passage through which the item ejected from the item ejection port is transported to an item dispensing slot;

an optical sensor provided on the transportation passage at a position between the item ejection port and the item dispensing slot;

a handle whose rotation manipulation is manually performed; and

a control portion that causes the item to be ejected from the item ejection port by controlling rotation of the rotor corresponding to the rotation manipulation of the handle, and that causes sales data relating to the item to be transmitted to the outside when the rotation angle of the handle reaches 360 degrees or a predetermined angle, the rotor is rotated until any of the item holders is aligned with the item ejection port and, further, the optical sensor detects passing of the item through the transportation passage.

(9)

An item dispensing device includes:

a plurality of storage portions that store items;

an item ejection mechanism that is provided to each of the plurality of storage portions, that includes a disc-shaped rotor where a plurality of item holders each of which holds one of the items stored in the storage portion are arranged in a circumferential direction, an item ejection port provided at one portion on the circulating track of the item holder, and an electric motor for rotating the rotor, and that ejects the item held in the item holder from the item ejection port when any of the item holders is aligned with the item ejection port with the rotation of the rotor;

a cylindrical shared transportation passage through which the item ejected from the storage portion is transported to an item dispensing slot, the cylindrical shared transportation passage being used in common by the plurality of storage portions;

an optical line sensor provided immediately above the item dispensing slot on the shared transportation passage;

a handle whose rotation manipulation is manually performed; and

a control portion that controls the electric motor corresponding to the rotation manipulation of the handle to causes the item to be ejected from the item ejection port, and that causes sales data relating to the item to be transmitted to the outside when the rotation angle of the handle reaches 360 degrees or a predetermined angle, the rotor rotates until any of the item holders is aligned with the item ejection port, passing of the item through the line sensor is detected based on an output from the line sensor, and the number of items ejected from the storage portion and the number of items passing through the line sensor agree with each other based on an output from the line sensor.

(10)

The item dispensing device includes:

a plurality of storage portions that store items;

an item ejection mechanism that ejects one of the items at a time from any of the storage portions;

a cylindrical shared transportation passage through which the item ejected from the storage portion is transported to an item dispensing slot; and

a transmitting portion that transmits, to the outside, sales data relating to the item and including an identification number that individually identifies the storage portion.

(11)

In the server device connected to, via a communication line, a plurality of item dispensing devices that eject one item at a time from any of a plurality of item storage portions, and that are installed at a plurality of places, to a plurality of installer's terminal devices of installers who install the item dispensing devices, and to a plurality of item provider's terminal devices of item providers who provide the item, the server device includes:

a receiving portion that receives, from the plurality of item dispensing devices, sales data of the item including storage portion identification information that identifies the item storage portion and item dispensing device identification information that identifies the item dispensing device;

a totalization processing portion that totalizes the number of sales of items based on the sales data for each of the installers and each of the item providers; and

a transmitting portion that transmits the number of sales of items for each of the installers to the installer's terminal device which corresponds to the installer, and that transmits the number of sales of items for each of the item providers to the item provider's terminal device which corresponds to the item provider.

It should be appreciated that the present invention can be applied to various types of item dispensing devices, but not limited to the respective embodiments described above.

### REFERENCE SIGNS LIST

4 . . . shared transportation passage, 6 . . . handle, 10 . . . item dispensing device, 11 . . . stock case, 35 . . . electric motor, 50 . . . rotor, 52 . . . item holder, 57 . . . rotor switch, 111 . . . control portion, 116 . . . handle encoder, 143 . . . item ejection port

1. An item dispensing device, wherein
a plurality of storage portions that store items are individually detachably supported on a strut portion,
an item ejection mechanism that ejects one of the items at a time, a selection manipulation portion for allowing a customer to select the storage portion, and a display portion that displays a price relating to the item stored in the storage portion selected by the selection manipulation portion or attribution information of the item are individually attached to the plurality of storage portions, and
an item dispensing slot for allowing the customer to take out the item ejected from the storage portion, a transportation passage through which the item ejected from the storage portion is transported to the item dispensing slot, a trigger manipulation portion for allowing the customer to activate an ejection operation of the item ejection mechanism, and a settlement processing portion that performs settlement processing relating to vending of the item are equipped to the strut portion, and are used in common by the plurality of storage portions.

2. The item dispensing device according to claim 1, wherein
the item ejection mechanism is equipped with an electric actuator that generates power for ejecting the item, and
the strut portion is equipped with a control portion that integrally controls the electric actuator.

3. The item dispensing device according to claim 1, wherein
the strut portion is equipped with a reset manipulation portion for allowing the customer to cancel selection of the storage portion instructed by the customer via the selection manipulation portion.
